(19) United States
(12) Patent Application Publication
(10) Pub. No.: US 2018/0158039 A1
(43) Pub. Date: Jun. 7, 2018

(54) Mobile Vehicle Acquisition System and Method

(71) Applicants: Christine Frances Cox, Huntington, NY (US); James Thomas Lloyd, Phoenix, AZ (US)

(72) Inventors: Christine Frances Cox, Huntington, NY (US); James Thomas Lloyd, Phoenix, AZ (US)

(21) Appl. No.: 13/609,344

(22) Filed: Sep. 11, 2012

Related U.S. Application Data
(60) Provisional application No. 61/651,672, filed on May 25, 2012.

(51) Int. Cl. G06Q 20/20; G06Q 30/06; G06Q 50/30

(52) U.S. Cl. CPC G06Q 20/20; G06Q 50/30; G06Q 30/06

(57) ABSTRACT

A system may perform steps such as obtaining vehicle financing for a user requesting the financing from the computing device and providing financing information through a user interface on the computing device, processing a vehicle identification number received through communication with the computing device and providing a display of vehicle details on the computing device, determining and displaying a dealer location to the user and requesting and receiving user confirmation of the dealer locations and providing loan documents on the computing device and requesting user approval. The system may provide a payment interface upon receiving a user approval of the loan documents and transmit funds to the dealer upon receiving a user command.

### RELATED APPLICATIONS

This application claims priority from U.S. Provisional Application Ser. No. 61/651,672 filed on May 25, 2012.

### TECHNICAL FIELD

Embodiments of the invention are related generally to systems and methods for facilitating vehicle acquisition and ownership, and in particular to allowing vehicle acquisition to be completed through the use of a computing device such as a mobile device.

### BACKGROUND OF THE INVENTION

Currently, shopping for a vehicle can be a cumbersome process for the customer. Typically, customers go to one or more dealerships to look at and compare vehicles. Upon selecting a vehicle, the customer may need financing and will need insurance, titling, and registration processes completed. Often, the customer will also be negotiating a trade-in and if the customer wants a better deal, he may have to visit a different dealership. Even if customer selects a specific type of vehicle using online research, the customer may still be required to spend hours at a dealership obtaining all of the required items before driving away in the new vehicle.

Financial institutions currently offer more streamlined financing solutions, but these solutions are typically only available in bank branches and not at the point of sale. The dealer financing process can require a significant amount of time and the customer is unable to shop for other options while visiting the dealership. The dealer typically requires a written application from the customer and upon receiving the written application, the dealer submits it to various lenders for approval. Upon determining the best rate to the customer, the dealership may present that rate with additional charges. Accordingly, a solution is needed for improving and simplifying the vehicle purchasing experience for customers. A solution is needed that enables the customer to purchase a vehicle by making a single brief visit to a dealership or possibly without visiting a dealership out all.

A further problem exists in that once a customer purchases a new vehicle, the customer becomes responsible for keeping track of vehicle needs such as inspections, registration renewal, and servicing. Furthermore, the customer typically retains the original financing even if rates improve since the process of tracking and obtaining additional finance offerings can be particularly time consuming and cumbersome.

Accordingly, a solution is needed that will store vehicle data upon purchase of the vehicle and use the data to provide reminders, offers, and information to the customer throughout the lifecycle of the vehicle.

### SUMMARY OF THE INVENTION

Embodiments of the invention include a system for facilitating vehicle ownership, the system operating over a network and in conjunction with a user computing device. The system may include at least one computer memory storing instructions and at least one computer processor accessing at least one computer memory and executing the stored instructions for performing multiple steps. The steps may include obtaining vehicle financing for a user requesting the financing through the computing device and providing financing information to the user through a user interface on the computing device. The steps may additionally include processing a vehicle identification number received through communication with the computing device and providing a display of vehicle details on the computing device. The steps may further include determining and displaying a dealer location to the user and requesting and receiving user confirmation of the dealer location and providing loan documents on the computing device and requesting user approval. Additionally, the steps may include providing a payment interface upon receiving a user approval of the loan documents and transmitting funds to the dealer upon receiving a user command to transmit the funds.

In an additional embodiment, a method is provided for facilitating vehicle ownership, the method operating over a network and in conjunction with a user computing device. The method may include accessing instructions stored in at least one computer memory and executing the stored instructions for performing steps. The steps may include obtaining vehicle financing for a user requesting the financing through the computing device and providing financing information through a user interface on the computing device. The steps may further include processing a vehicle identification number received through communication with the computing device and providing a display of vehicle details on the computing device. The steps may additionally include determining and displaying a dealer location to the user and requesting and receiving user confirmation of the dealer location and providing loan documents on the computing device and requesting user approval. The steps may further include providing a payment interface upon receiving a user approval of the loan documents and transmitting funds to the dealer upon receiving a user command to transmit the funds.

In embodiments of the invention, the mobile user may scan the vehicle identification number with the computing device for transmission to the computer processor. Additionally, in embodiments of the invention, the processor may be programmed to display a vehicle comparison.

In embodiments of the invention, vehicle data may be stored by the vehicle management system upon purchase so that the system may trigger reminders and notifications through the life cycle of the vehicle. Additionally, the system may store data for multiple vehicles to create a virtual garage of vehicles for the user.

### BRIEF DESCRIPTION OF THE DRAWINGS

The present invention is described in detail below with reference to the attached drawings figures, wherein:

FIG. 1 is a block diagram illustrating an operating environment for a vehicle acquisition and management system in accordance with an embodiment of the invention;

FIG. 2 is a block diagram illustrating a vehicle acquisition and management computing system in accordance with an embodiment of the invention;

FIGS. 3A and 3B are flow charts illustrating a processing method for vehicle acquisition in accordance with embodiments of the invention;

FIG. 4 is a flowchart illustrating a vehicle management method in accordance with an embodiment of the invention;

FIGS. 5A and 5B illustrate a user login interface to the system in accordance with an embodiment of the invention;

FIG. 6 illustrates a user interface illustrating a home screen for the vehicle acquisition and management system in accordance with an embodiment of the invention;

FIG. 7 is a user interface illustrating transitioning from the home screen to offer details of a vehicle financing offer in accordance with an embodiment of the invention;

FIG. 8 is a user interface illustrating a transition from the home screen to a vehicle selection screen in accordance with embodiments of the invention;

FIG. 9 is a user interface illustrating scanning of a vehicle identification number in accordance with an embodiment of the invention;

FIG. 10 is a user interface illustrating dealer location for the vehicle acquisition and management system in accordance with an embodiment of the invention;

FIGS. 11A-11D are user interfaces illustrating a dealer confirmation process for the vehicle acquisition and management computing system in accordance with an embodiment of the invention;

FIG. 12 is a user interface illustrating vehicle details for the vehicle acquisition and management system in accordance with embodiments of the invention;

FIG. 13 is a user interface illustrating new vehicle details with research for the vehicle acquisition and management system in accordance with embodiments of the invention;

FIG. 14 is a user interface illustrating used vehicle details with research for the vehicle acquisition and management system in accordance with embodiments of the invention;

FIG. 15 is a user interface illustrating a vehicle comparison for the vehicle acquisition and management system in accordance with embodiments of the invention;

FIG. 16 is a user interface illustrating loan details for the vehicle acquisition and management system in accordance with embodiments of the invention;

FIG. 17 is a user interface illustrating e-signing screens for the vehicle acquisition and management system in accordance with embodiments of the invention;

FIG. 18 is a user interface illustrating payment screens for the vehicle acquisition and management system in accordance with embodiments of the invention; and

FIG. 19 is a user interface illustrating a confirmation of purchase screen for the vehicle acquisition and management system in accordance with embodiments of the invention.

### DETAILED DESCRIPTION OF PREFERRED EMBODIMENTS

Embodiments of the present invention are directed to a system and method for vehicle acquisition and management. The system simplifies the vehicle acquisition process by providing financing approval to a customer via a computing device, processing the vehicle's vehicle identification number remotely, and allowing for payment to the dealer immediately. The system allows customers to bypass the cumbersome dealer financing process.

The system of the invention can operate in real time, is paperless, and completely automated. The system is operable through the use of a user computing device such as a mobile device connected. The computing device may be connected with the Internet. Use of the system improves the customer experience in the dealership by allowing for shortening the time with financing personnel and possibly bypassing the dealer financing process. This enables a significant time savings for the customer.

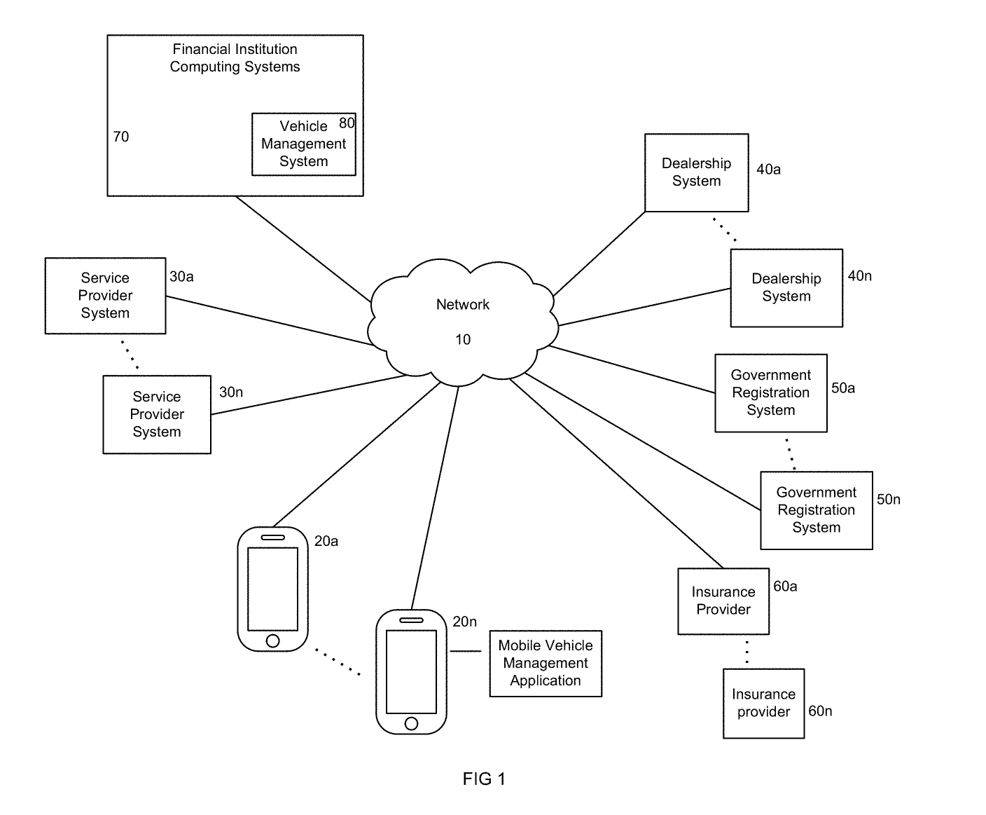

FIG. 1 is a block diagram illustrating an operating environment for a vehicle acquisition and management system in accordance with an embodiment of the invention. A financial services organization 70 may include a vehicle management and acquisition system 80 and may connect over a network 10 with customer computing devices, which may be mobile devices 20a . . . 20n. The mobile devices 20a . . . 20n may store a mobile vehicle management application. Other systems connected over the network 10 may include service provider systems 30a . . . 30n, dealership systems 40a . . . 40n, government registrations systems 50a . . . 50n and insurance provider systems 60a . . . 60n. Other systems not shown may also be connected.

The network 10 is preferably the Internet, but may be or include other types of networks. Furthermore, even though only one network is shown, multiple networks may be used. For example, service provider systems 30 may communicate over a different network with the financial services computing system 70 than the dealership computing system 40. The network 10 may include a wired or wireless local area network (LAN) and a wide area network (WAN), wireless personal area network (PAN) and other types of networks. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

The computing devices 20a . . . 20n preferably store a vehicle management application that interfaces with the vehicle management system 80. The computing devices 20a . . . 20n may be or include any personal computing device such as a laptop or desktop computing device or handheld mobile devices with internet access such as iPhones or other mobile phones, iPads or tablets, or any other known mobile devices. In embodiments of the invention, the mobile devices may be equipped with cameras for photo identification purposes, and may also be equipped with features for facilitating biometric identification as will be further described below

The service provider systems 30a . . . 30n may include computing systems of entities performing vehicle maintenances or repair services or other vehicle services. These service provider systems 30a . . . 30n may in embodiments of the invention, generate special offers and or reminders of servicing due and transmit these offers to components of the vehicle management and acquisition system 80.

The dealership systems 40a . . . 40n may also be connected, but need only be capable of receiving electronic payments in order to function in conjunction with the vehicle management and acquisition system operated by the financial institution. However, in embodiments of the invention, the dealership systems 40a . . . 40n may send and receive information. The dealership systems 40 may provide data, including dealership information and vehicle information to the vehicle acquisition and management system 80.

The government registration systems 50a . . . 50n may be or include systems of different states The systems are preferably operated by the Department of Motor Vehicles or Motor Vehicle Administration of the state and are capable of providing and receiving information regarding vehicle registration and inspection. The vehicle acquisition and management system 80 may generate reminders based on this information.

The insurance provider systems 60a . . . 60n may be or include computing systems operated by vehicle insurance providers. The insurance provider systems 60a . . . 60n may communicate with the vehicle management and acquisition system 80 in order to offer quotes on insurance products that conform to local regulations. The system 80 may be equipped to compare quotes for the customers.

The financial institution computing systems 70 include those computing systems commonly associated with financial institutions, such as account processing systems and credit card processing systems, and further may include the vehicle management and acquisition system 80 as further described herein.

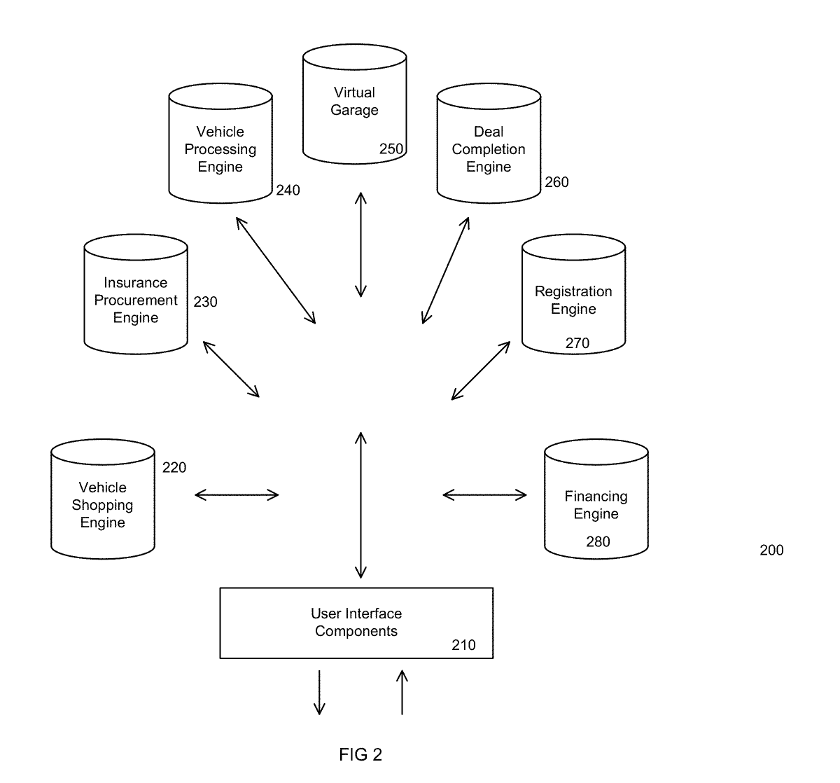

FIG. 2 is a block diagram illustrating a vehicle acquisition and management computing system in accordance with an embodiment of the invention. The vehicle acquisition and management computing system 200 may include computing components such as a computer memory, computer interfaces, and computer processors. The computer processor is capable of accessing data from memory and of accessing and executing programs from memory. The vehicle acquisition and management computing system 200 may include user interface components 210, a vehicle shopping engine 220, an insurance procurement engine 230, a vehicle processing engine 240, a virtual garage 250, a deal completion engine 260, a registration engine 270, and a financing engine 280. Other engines or components may also be included that communicate over the Internet or other network with external systems

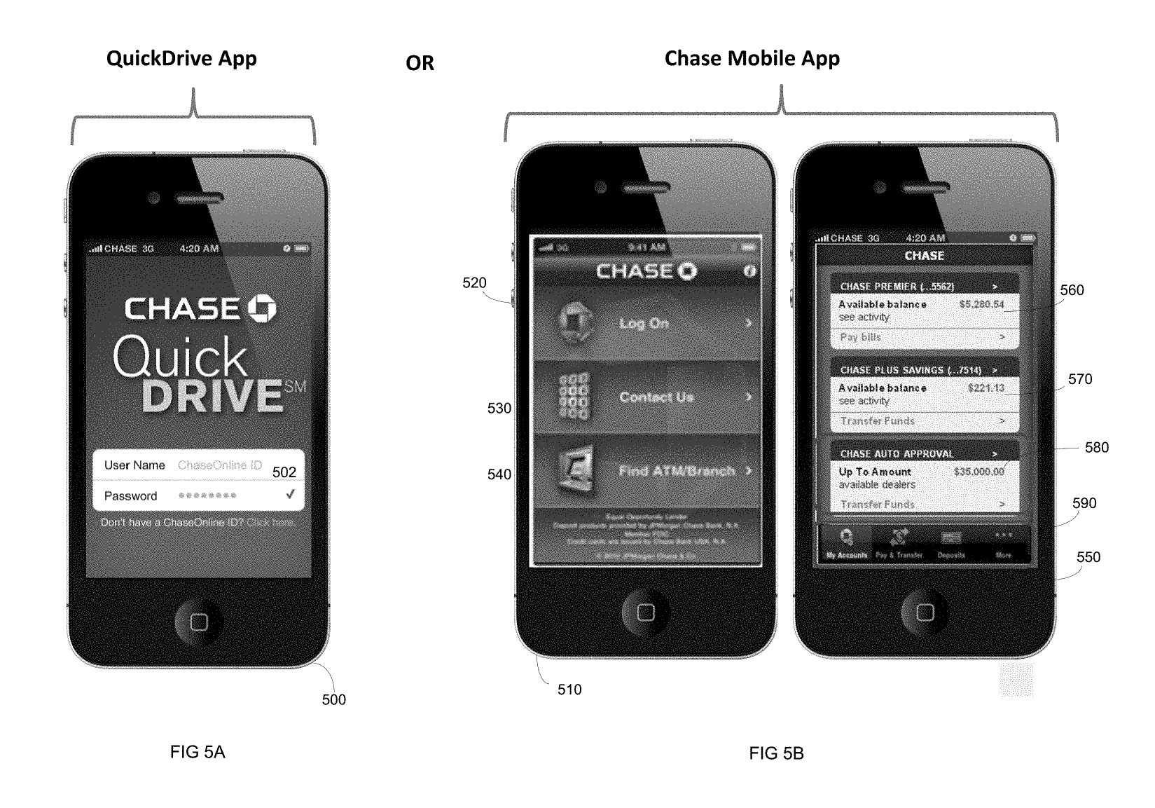

The user interface components 210 may be provided through the mobile device to guide system users through the vehicle acquisition process and subsequently the vehicle management process. Exemplary user interfaces will be further described below with reference to FIGS. 5-19.

The vehicle shopping engine 220 may operate in conjunction with a dealer system to allow a user to shop for a vehicle online. The customer may use a mobile application or may browse a dealer website or proprietary website. The vehicle shopping engine preferably provides access to all available vehicles at participating dealerships. In addition to data from participating dealerships, data may also be provided from individuals selling vehicles. Thus, the vehicle shopping engine may allow a user to shop for both new and used vehicles online.

The insurance procurement engine 230 may interface with the above-described insurance provider systems to obtain one or more insurance quotes for each customer. This engine preferably operates in real time to enable the system user to procure insurance during the purchase process before removing the purchased vehicle from the dealership. However, the engine may also operate intermittently to produce special offers during the life of a vehicle.

The vehicle processing engine 240 provides for processing of the vehicle based on the VIN received from the mobile user. The VIN may be manually entered through a touch screen or through voice recognition or other input device. Alternatively, the user may utilize the mobile device to scan the VIN or take a photograph of the VIN so that the vehicle processing engine 240 can retrieve stored vehicle data from an internal or external system. The vehicle processing engine 240 may retrieve all of the vehicle details including an image of the vehicle to be displayed on the user's mobile device. The vehicle processing engine 240 may also request confirmation from the user that the vehicle described and displayed is indeed the vehicle that is currently under consideration by the user for purchase. The vehicle processing engine 240 may also confirm dealer details to ensure that the customer is purchasing the vehicle through a dealer registered with the vehicle acquisition and management system. The vehicle processing engine 240 may also process and provide information about trade-in vehicles when the VIN is entered. The vehicle processing engine 240 may also save specific vehicles and their information to facilitate user comparison and review. For example, the vehicle processing engine may save the VIN, photograph, options, dealership, and price, so that users can later compare vehicles for purchase.

The virtual garage 250 may collect and store data pertaining to any vehicle registered with the system, Any vehicle purchased through the system can be automatically registered. Other vehicles owned or maintained by a system user can be manually entered into the system by the user. The virtual garage 250 may store or access data such as warranty information, servicing requirements, registration and inspection requirements, financing details, and repairs. The virtual garage 250 may track this information in order to generate reminders and offers that can be displayed on user computing devices. The virtual garage 250 may also evaluate the value of the car and the cost of a recommended repair and generate messages recommending a new car purchase. In embodiments of the invention, the virtual garage 250 may respond to user prompts to set up appointments for servicing or to obtain updated registration documents. The virtual garage 250 may also connect the user with financing alternatives if prompted by the user, or may proactively provide refinancing opportunities based on the stored data.

The deal completion engine 260 provides the user with confirmation screens and the ability to e-sign documents as required through web and mobile channels. The deal completion engine 260 may also ensure that financing is completed and that the funds are transferred to the dealer for purchase. The funds transfer may occur through known processes, such as, for example, JP Morgan Chase's Quick Pay℠., ACH, or check.

The registration engine 270 may be provided to connect the system with government agencies facilitating registration, licensing, and inspection. In embodiments of the invention, the registration engine 270 may cause the registration process to be completed and have registration documents delivered to the system user during or subsequent to the purchase of a vehicle.

The financing engine 280 is preferably provided through the financial institution. In embodiments of the invention, the user is a customer of the financial institution and is directed to an interface for financing upon login, while in other embodiments, the user is not a customer of the financial institution. The financing engine 280 is able to process a user request for financing in real time and provide an offer for a loan to purchase the vehicle. The offer may be modified or reissued upon entry of the VIN. The financing engine 280 preferably provides a user interface with drill down options so that system users can view the details of the financing offer on the computing device. In embodiments the invention, the financing engine 280 may leverage the relationship between a financial institution and dealership or manufacturer. For example, the financial institution may be a non-captive financer that is able to provide financing for a virtually unlimited number of automobile mobile manufacturers and dealers. By leveraging this relationship, the system may present the customer with a subvented financing offer through a mobile, web, or branch application. Accordingly, the financing engine 280 may communicate with the manufacturer and/or dealership systems to arrive at an offer that will likely be the most attractive offer to the customer as a result of the manufacturer's subvention of the rates and or vehicle price that is presented to the customer. For example, the manufacturer may enter into an agreement with the financial institution in order for the financial institution to provide a zero percent (or other attractive percentage) financing offer to the customer. The manufacturer may pay a fee to the financial institution for offering this service. The manufacturer may be motivated to move certain inventory and therefore may be agreeable to pay the financial institution a fee equivalent to the finance charge that the financial institution would have received had it offered a less favorable rate. In embodiments of the invention, the financing engine 280 may provide these subvented offers for purchase of new or used vehicles as well as for vehicle leasing. (Need explanation) How about mitigating mark up? Or the paying of a flat fee. title perfection process?

The engines described above may include software components including instructions executed by one or more computer processors to perform the functions described. The engines may include or access databases stored in computer memory to obtain data necessary for execution of instructions. Databases may be provided and accessed both within financial services computing systems and outside of the financial services organization.

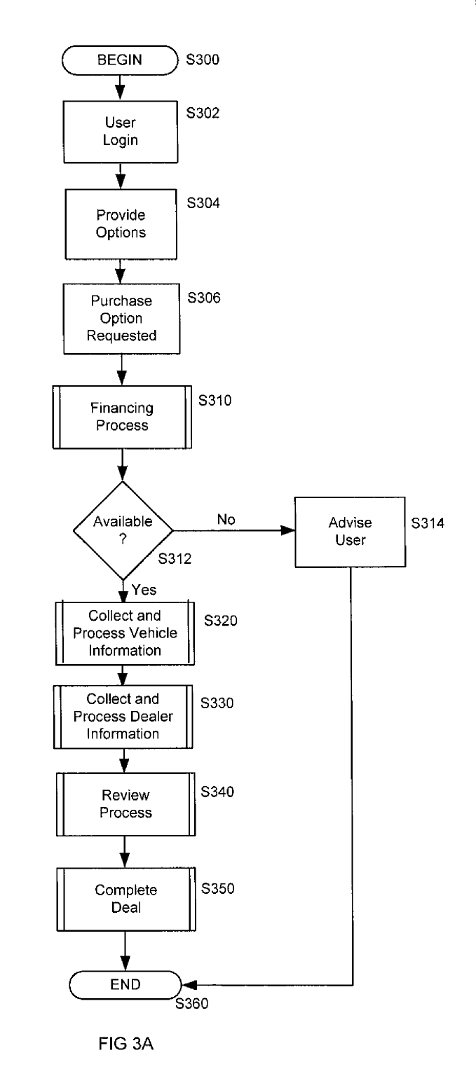

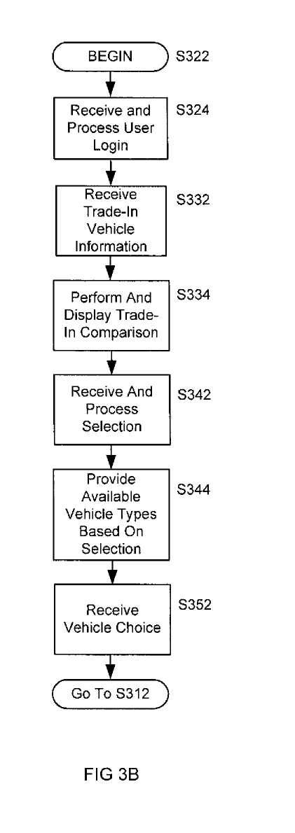

FIG. 3A is a flow chart illustrating a processing method for vehicle acquisition in accordance with embodiments of the invention. The process begins in S300 and user login is received in S302. In S304, the system provides options to the user. The present flow assumes that the user exercises a purchase option in S306. However, in embodiments of the invention, the user may alternatively be updating registration documents, scheduling appointments for servicing or inspection, or performing other functions

Upon selection of the purchase option in S306, the system begins a financing process in S310. The financing may be for purchasing a new or used vehicle. If the system determines that financing is not available in S312, it will advise the user in S314. Alternatively, if the system determines that financing is available in S312, after displaying the financing offer or offers to the user during finance processing, the system will collect vehicle information in S320. The system may make financing offers based on such factors as user income and credit worthiness and financial institution relationship. In embodiments of the invention, the user may already be a financial institution customer. In this instance, the user may be pre-approved. In other instances, the user may receive an invitation to apply that may result in an instant decision. As set forth above, upon receiving the VIN number which is either manually entered or scanned by a user computing device or spoken or entered into the computing device, the system retrieves additional details regarding the vehicle. These details may be stored in a dealership system or any system connected over the network. The customer may be asked to confirm the vehicle details prior to processing of the purchase. In embodiments of the invention, the system may offer details regarding additional vehicles if requested by the user. In S330, after processing the vehicle information, the system collects and processes dealer information. The system may be able to identify the dealer based on its location of record of the vehicle or the location of the mobile device. The user may be asked to confirm the dealer details and location through a user interface. Alternatively, the user may manually enter dealer details.

In S340, the system conducts a review process in which details of financing, the vehicle, the dealership, and user information are confirmed. In embodiments of the invention, other procedures may occur during the review process, such the storage of relevant data in the virtual garage. Also, the system may be adapted to perform registration and insurance functions as described above. In embodiments of the invention, additional processes may be incorporated in order to accomplish registration and insurance coverage. Alternatively, the system may merely notify the user of the requirements for insurance coverage and registration during the review process if the system is not adapted to perform the registration and insurance coverage functions automatically.

In S350, the system completes the deal. Deal completion may include e-signing, on mobile or web applications, of documents and transmission of funds to the dealer. In embodiments of the invention, all of the above steps may be performed for the user regardless of the user's location. For example, the user may not even be required to visit the dealership and may accomplish all of the above described functions remotely via the Internet The user may then pick up the vehicle at the dealership after the process is complete or alternatively, the dealer may deliver the vehicle directly to the customer. In embodiments of the invention, the dealer may deliver the vehicle directly to the customer and simultaneously pick up a used vehicle being traded in. The process ends in S360.

FIG. 3B illustrates a preliminary process that may be executed by the vehicle acquisition and management system when a user has a trade-in vehicle. The process begins in S322 and the system receives and processes a user login in S324. In S332, the system receives trade-in vehicle information. This information may be manually entered by the user or may be transmitted through VIN capture. In some instances, this information may already have been stored in the system by the user upon initial purchase of the vehicle. In S334, the system performs a trade-in comparison and displays the comparison for user viewing and selection. The comparison may include a customer worksheet for customer manipulation to enable the customer to compare options across various parameters. In embodiments of the invention, the trade-in comparison provides a plurality of entities accepting the vehicle for trade-in and the amount that these entities would provide for the trade-in. In S342, the system may receive and process a user selection for the particular trade-in parameters. Based on the selection, in S344, the system may evaluate the user's purchasing capability and provide a display of appropriately priced vehicles. In S352, the system may receive a user selection of a vehicle. Finally, the system may return to S312 of FIG. 3A to explore financing options. Other sequences of steps are also within the scope of the invention. For example, users may retain the trade-in comparison for information, but may instead decide to donate the vehicle or sell it to a friend or neighbor. In embodiments of the invention, the system may be equipped to assist with these processes, for example, by providing information on the Kelley Blue Book™ or 3^{rd} party value for donation, or facilitating the transfer of the vehicle to the friend or neighbor, or providing financing for a friend.

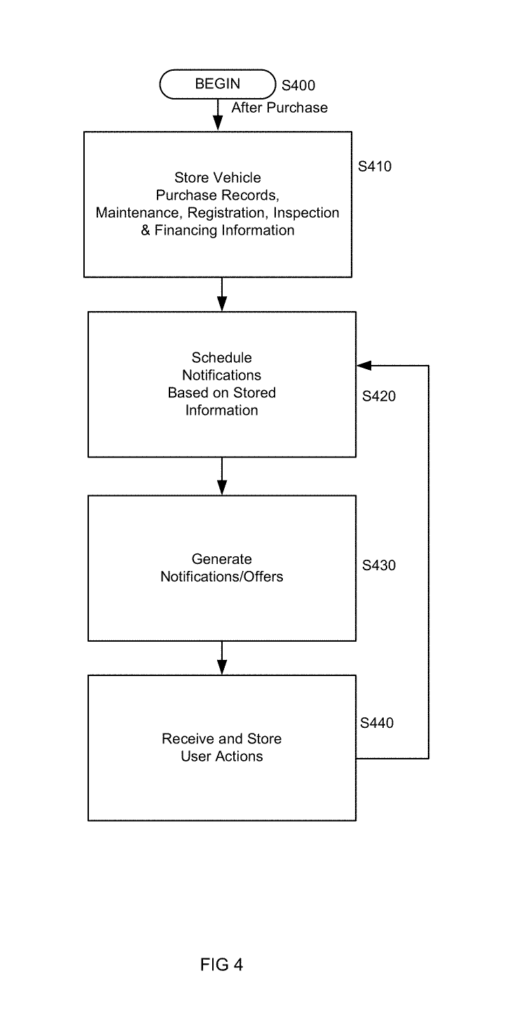

FIG. 4 is a flowchart illustrating a vehicle management method in accordance with an embodiment of the invention. The method begins in S400. In S410, the system may store vehicle purchase records, as well as maintenance, registration, inspection, and financing information for a purchased vehicle. In S420, the system may schedule notifications and/or based on stored information. In S430, the system may generate those notifications and offers in accordance with the schedule, and in S440, the system may receive and store user actions in response to the notifications. Based on the user actions, the system may store information about the actions and schedule additional notifications. For example, the user may obtain an oil change. The system may record the vehicle mileage at the time of the oil change and schedule the next oil change. These functions may be performed by the virtual garage, which is capable of updating itself throughout the lifecycle of the vehicle.

In embodiments of the invention, the system may provide additional services and perform addition functions. For example, the system may allow for mobile or web purchase of an extended warranty from the system proprietary or 3^{rd} party. The system may also include filters to ensure that users only receive offers and reminders in which they may legitimately have an interest based on their purchases. The system may further perform a negotiation function for automated negotiation with a dealer on the price of the car. Accordingly, an end state may be that a user selects a vehicle on-line with pre-negotiated price, purchases insurance, obtains registration documents and title, and completes the entire transaction without going to dealership. The customer could report to the dealership to obtain the vehicle, or the vehicle may be delivered. In another embodiment, the customer takes his mobile device to the dealership and captures an image of the VIN. The system then finalizes its processing and the customer obtains the keys. The system negotiates with and pays the dealer without any requirement for the user to interact with the dealer regarding payment or price. The user may want to visit the dealership just to see the vehicle before purchase.

The system may prompt the customer regarding the status of the purchase process and offer pre-negotiated deals on servicing, refinancing, etc. After moving through the life cycle of the vehicle, the customer may want to purchase another vehicle. The system could advise the user regarding how much equity the user has in the vehicle. The system can leverage its relationship with dealers to provide pre-negotiated rate for trade in of car. When the dealer drops off a newly purchased vehicle, the dealer can pick up the old one. In embodiments of the invention, the system may manage a fleet of vehicles for any customer having more than one vehicle.

With regard to financing, the system attempts to provide a thorough analysis of all options. The customer may want to see a relative comparison of leasing versus buying or may want to know what happens to the financial picture upon trade-in or lease payoff.

An objective of the system is to simplify the vehicle purchasing process for the customer. In addition to operating with dealers, the system may also be available to users buying a car from a neighbor, a friend, or through classified ads. The system in this instance may be available for performing registration, titling, insurance, financing, and other functions. The operation would differ primarily in the dealer verification process. In this instance, the user would merely be required to enter details of the seller. The system may be available to facilitate new and used car purchases and also to assist with refinancing of a vehicle that has previously been financed.

All of the components shown in FIGS. 1-4 above may be, include, or be implemented by a computer or multiple computers. The system of the invention or portions of the system of the invention may be in the form of a “processing machine,” i.e. a tangibly embodied machine, such as a general purpose computer or a special purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example. As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

FIGS. 5A and 5B illustrate a user login interface to the system in accordance with an embodiment of the invention. FIG. 5A illustrates a log in interface 500 as the user may be required to log into the system in order to be authenticated. A user name and password as well as other authentication factors may be required. FIG. 5B illustrates a home screen 510 for the financial institution including a log on option 520, a contact option 530, and a “find branch” option 540. Once the user has logged in, a user interface 550 may display available accounts 560 and 570 as well as an auto loan approval option 580. Icons 590 may provide account related options.

Variations may be provided for various modes of operation. For example, a customer may log into the system to purchase and/or finance a new car or a used car. Furthermore, a customer may have a car for trade-in and may want to expedite both the trade-in and purchase by traversing user interfaces provided through the disclosed system. Accordingly, a series of interfaces may be provided to consecutively guide the user through the trade in and purchasing processes.

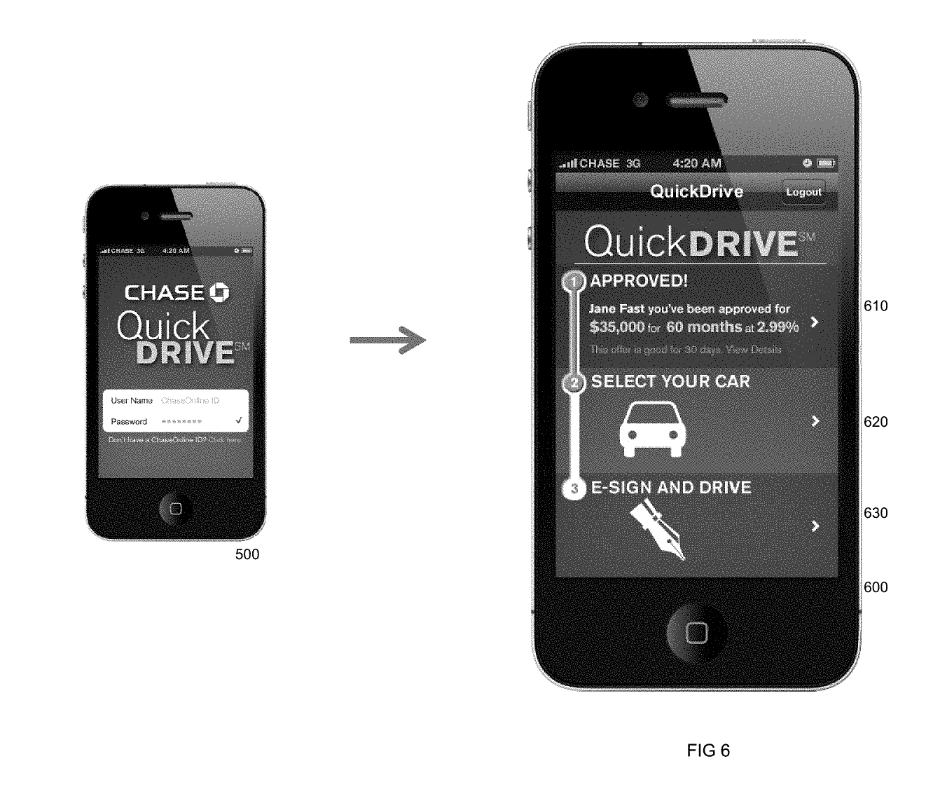

FIG. 6 illustrates a user interface including a home screen 600 for the vehicle acquisition and management system in accordance with an embodiment of the invention. After the user logs on at screen 500, the user interface 600 provides a stepwise interface including an approved step 610 related to financing approval, a vehicle selection interface 620 for selecting a particular vehicle, and an e-sign and fund dealer interface 630 for allowing document signature and transfer of funds. The interface 600 may also include a bar for measurement of progress.

Although FIG. 6 shows financing approval prior to car selection, these procedures may also occur in reverse. In this instance, the customer may activate a mobile application and enter a vehicle by capturing the VIN or otherwise capturing images of the vehicle. In some instances, the customer may also be required to enter a vehicle price. In response to the identification of the vehicle and the vehicle price, the mobile application may offer financing options for the particular selected vehicle. In embodiments of the invention, multiple financing options may be provided, each having different interest rates, time periods, down payments etc. If a customer requests 100% financing, the system may counter offer some lesser portion of financing.

In further embodiments of the invention, upon entry of a vehicle type and/or VIN number, the system may activate a car comparison application. This application may be particularly useful when the customer is purchasing a used car. Accordingly, the system may display similar cars and their mileages, models, years, price, location, and competitive market price.

Furthermore, although not shown in FIG. 6, the customer may step through interfaces for both a trade-in and a purchase. The screens may first produce evaluations of trade-in value and may give the customer parameters pertaining to the purchase of a new vehicle based on the trade-in. For example, the system may inform the customer how much financing is available to that customer for a new car based on the trade-in value and the user's financial parameters and may further offer vehicle comparisons for vehicles falling into an affordable price range for the customer. If a customer chooses a vehicle outside of his or her price range for financing, the system may offer additional alternatives.

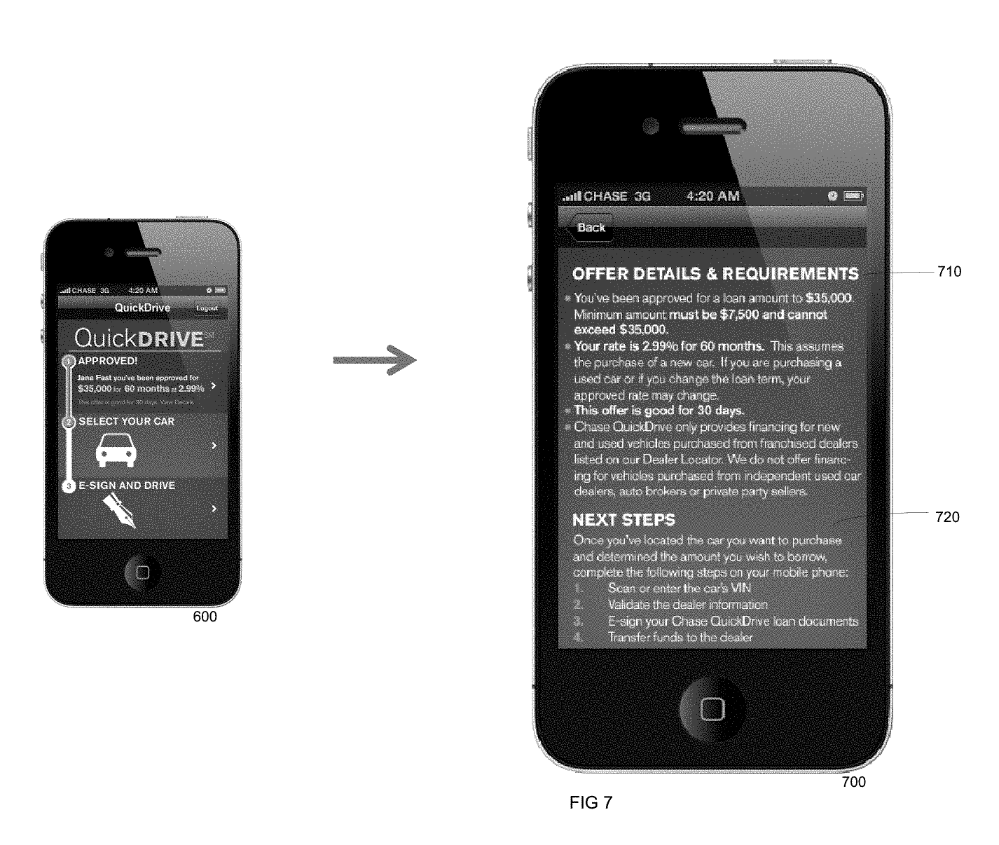

FIG. 7 is a user interface illustrating transitioning from the home screen to offer details of a vehicle financing offer in accordance with an embodiment of the invention. From the home screen 600, if the user selects step 1 (the “approved” step), the user may be directed to additional details about the offer 710 and next steps 720 on the screen 700.

In embodiments of the invention, the user interface may provide a “chat” option to allow customers to interact in real time with a loan officer. In addition to online chat, live telephone intervention options may be provided.

In embodiments of the invention, financing options may include refinancing for a vehicle already owned by the customer. In this instance, the VIN may also be scanned. The system may determine, through input entered through a series of user interfaces or through externally gathered intelligence, what loan package is in place and request payoff information. Based on the gathered information, the system could offer refinancing alternatives for the vehicle.

In embodiments of the invention, the system leverages cross marketing opportunities by offering refinance packages even if the user has not applied or by offering cut rate insurance to the user whenever the user logs onto the system. The system may be encompassed within a mobile banking system. Accordingly, when a customer logs in for mobile banking, even if the banking is unrelated to vehicle financing, the system may provide offers for insurance, refinancing, or other products.

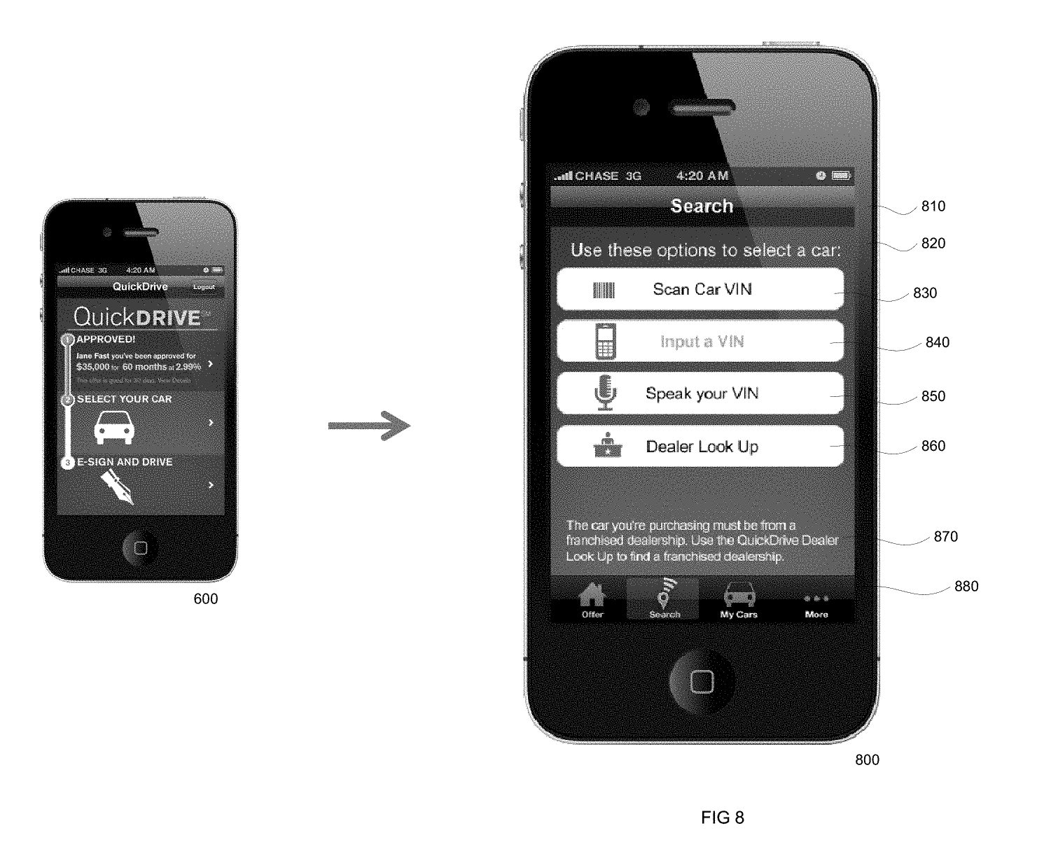

FIG. 8 is a user interface illustrating a transition from the home screen to a vehicle selection screen in accordance with embodiments of the invention. From the home screen 600, the user may selection option 2, (the “select your car” option) and may be directed to the interface 800. The interface 800 may include a search function 810, a scan car VIN option 830, an input VIN option 840, a speak VIN option 850, a dealer look up option 860 and dealer look up information 870. The user may find any franchised or independent dealer in the US via the dealer look-up, or may be provided with a list of preferred dealerships recommended a financial institution. The interface 800 may also include icons 880 allowing for switching between functions.

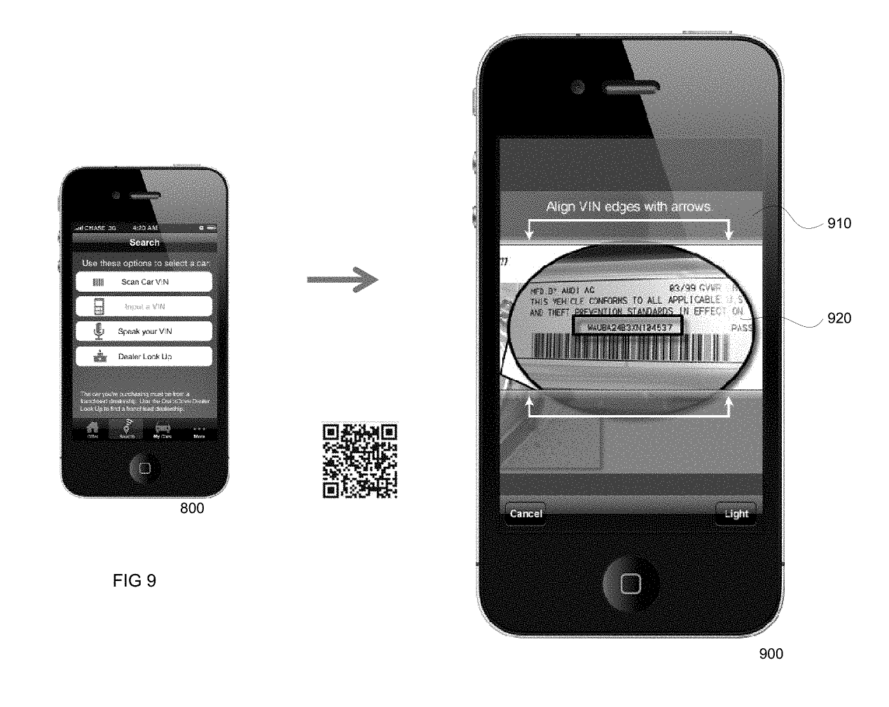

FIG. 9 is a user interface illustrating scanning of a vehicle identification number in accordance with an embodiment of the invention. From the interface 800, it may also be possible to leverage QR functionality in which instructions 910 may be provided in order to capture VIN 920.

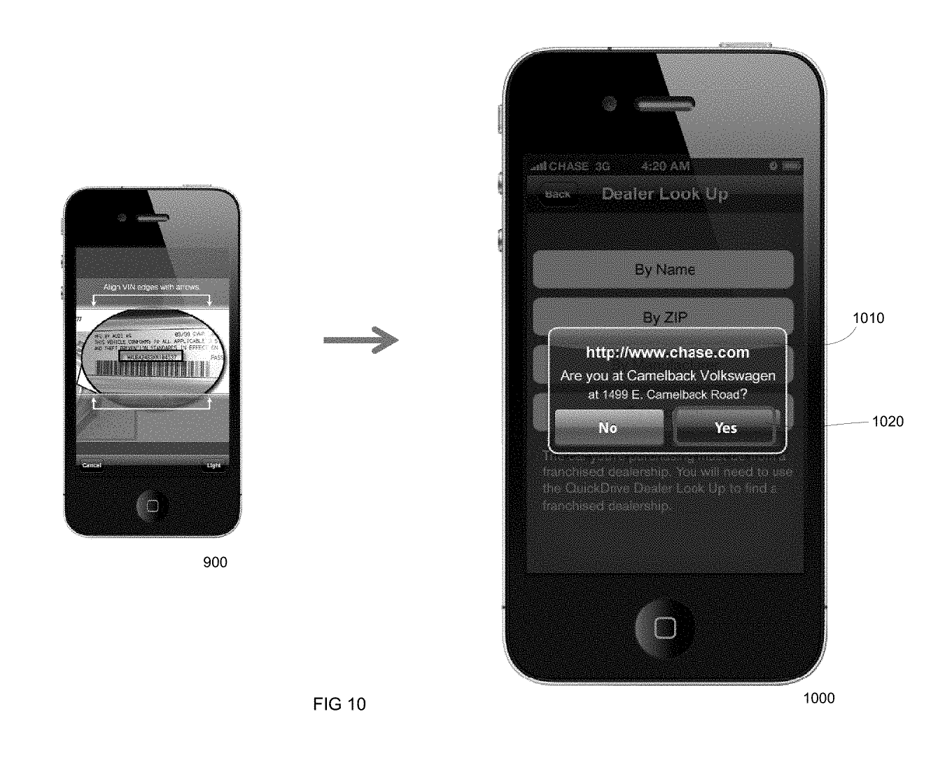

FIG. 10 is a user interface illustrating dealer location for the vehicle acquisition and management system in accordance with an embodiment of the invention. In embodiments of the invention, geo-location may be used at 1010 to determine the dealer location. The user may be asked to confirm the location at 1020.

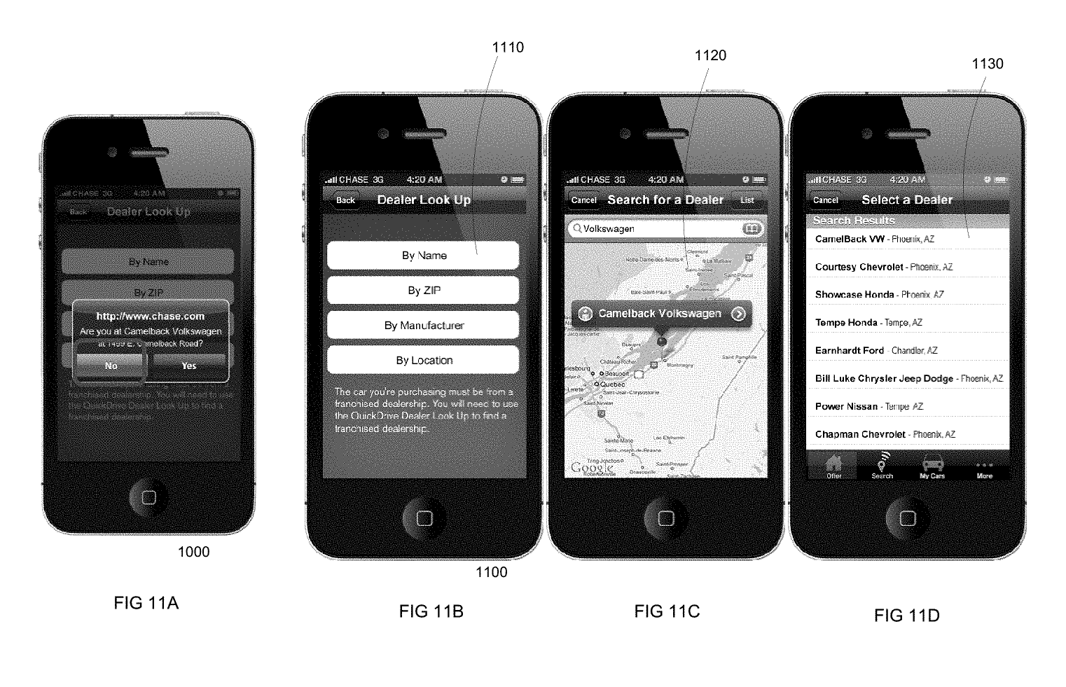

FIGS. 11A-11D are user interfaces illustrating a dealer confirmation process for the vehicle acquisition and management computing system in accordance with an embodiment of the invention. If the system is unable to identify the dealership by geolocation, the customer may be provided with the ability to select a franchised dealer. Interface 1000 shows the confirmation screen. Interface 1100 shows a dealer lookup screen having various lookup options 1110. FIG. 11C shows a dealer map search screen 1120 and FIG. 11D illustrates a select-a-dealer screen 1130. The customer may have the ability to have his or her ‘loan approval’ sent directly to the dealership.

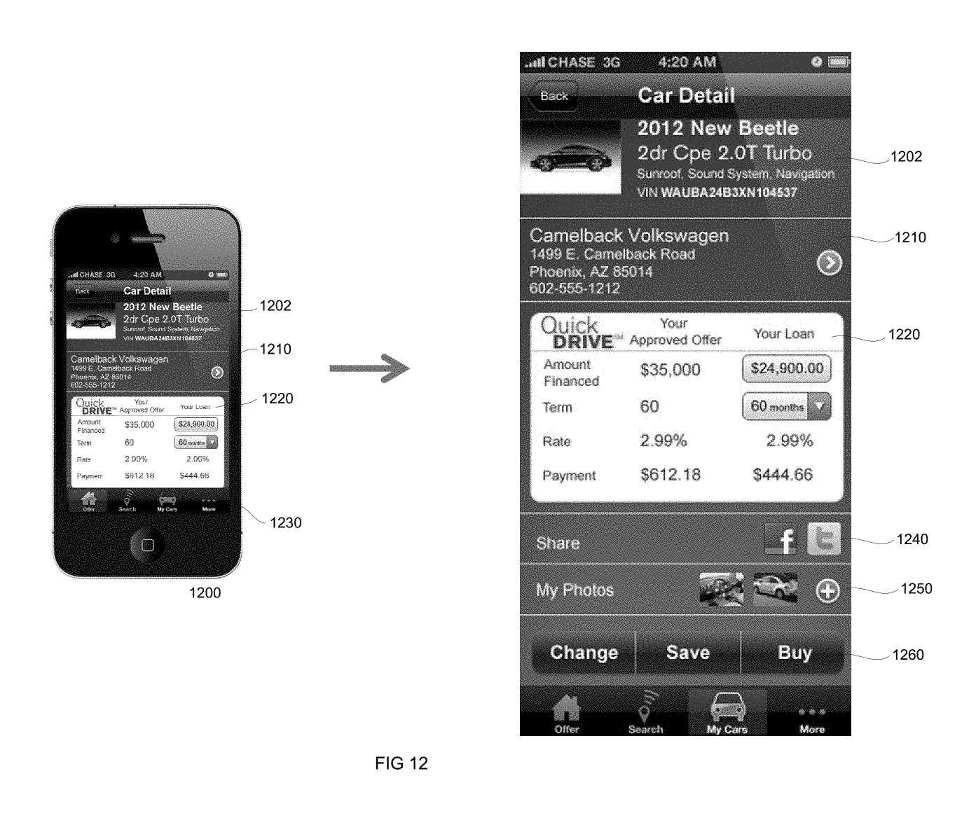

FIG. 12 is a user interface illustrating vehicle details for the vehicle acquisition and management system in accordance with embodiments of the invention. Once the customer has provided the VIN and confirmed the dealer, the customer may be provided with the ability to modify the loan offer. An interface 1200 may provide a car detail section 1202, a dealer section 1210, a finance section 1220 and icons 1230. The interface may also include a social network sharing option 1240 and a photo storage option 1250. The customer can save the car to a “my cars” option or move forward using a buy icon 1260.

If the customer is trading a car in and scans the VIN, the system determines either through internal intelligence or through input from the customer, various details pertinent to the vehicle. For example, the system may determine whether the vehicle is financed and where financing was obtained. The system may further determine a likely trade-in value for the vehicle and may provide multiple locations at which the trade-in-value may differ. Based on this information, the user may choose a trade-in location based on the location, the amount offered, or a combination of factors. In embodiments of the invention, the system itself may accept a trade-in vehicle and offer to pick up the vehicle from the dealer or individual selling the new or used vehicle to the customer.

All of the aforementioned data may be centrally stored on the system. Accordingly, the customer does not become reliant on a particular computing device or mobile device and is able to access data from the “cloud.”

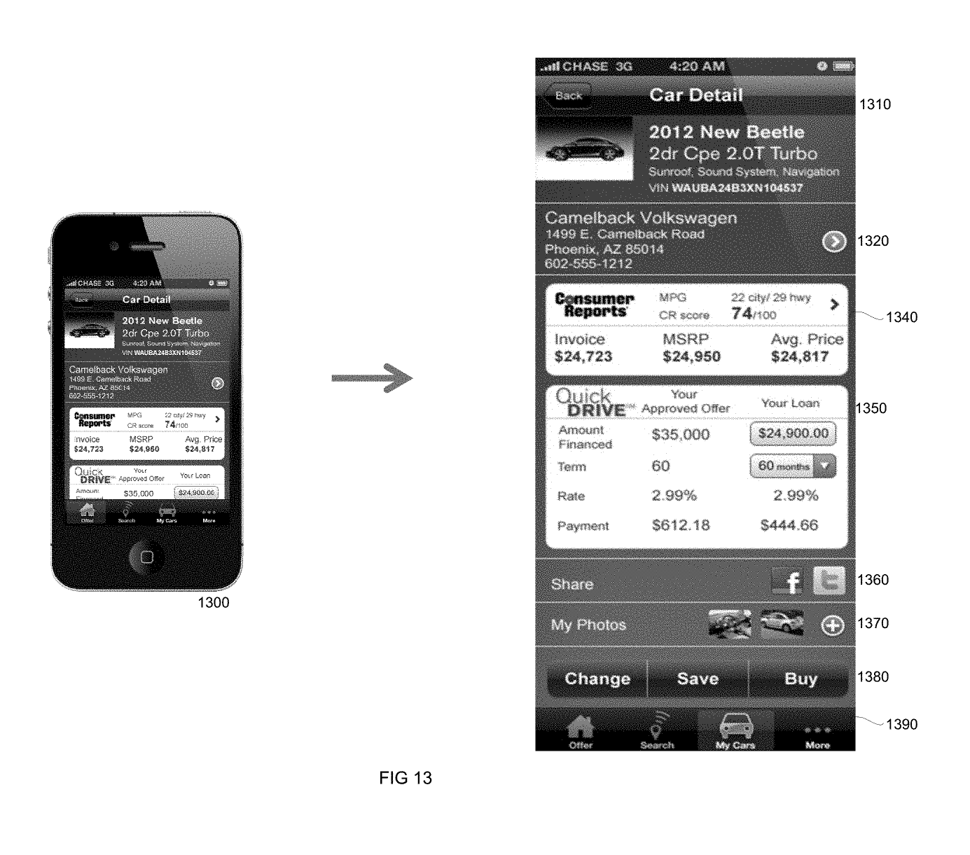

FIG. 13 is a user interface illustrating new vehicle details with research for the vehicle acquisition and management system in accordance with embodiments of the invention. The customer may be provided with high level third party information and be provided with the ability to click through or drill down for additional details. From a screen 1300, the user may view car details 1310 including car history reports, dealership information 1320, customer reports information 1340, financing information 1350, social networking information 1360, and photos 1370. The user may also choose options 1380 such as change, save, or buy. The user may also select any one of icons 1390 to perform additional functions.

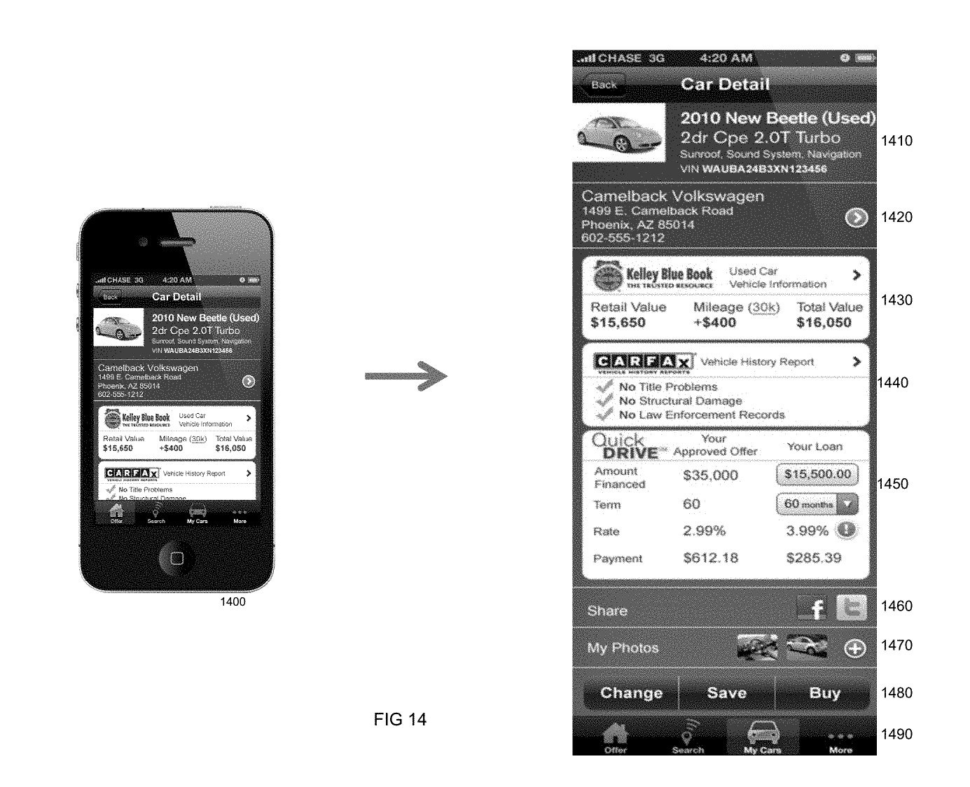

FIG. 14 is a user interface illustrating used vehicle details with research for the vehicle acquisition and management system in accordance with embodiments of the invention. This interface is substantially the same as that provided in FIG. 13, except that additional details may be provided for used cars. An interface 1400 includes car detail 1410, dealership information 1420, 3^{rd} party car valuation and market price information 1430 regarding used car value, car history reports/information from 3^{rd} party 1440, financing information 1450, social networking options 1460, photos 1470, and options 1480 and 1490. The interface may also include features that enable comparison of multiple vehicles.

Often, in the case of used vehicles, different issues may arise with payment and titling. These issues may arise especially in the context of purchases made from individuals rather than dealerships. Individuals may not have identified their vehicles or set up online payment. However, individuals may log into a system portal to utilize the online payment system to receive payments. Typically, the selling individual can log into the system with a name and/or email or cell phone number in order to accept funds. The system may display for the seller, on a seller interface, photographs, odometer reading, and other information pertaining to the vehicle and ask for verification that the information is correct.

Transfer of title must be verified in all cases including situations with a private seller. The transference of the title may be confirmed in one of multiple ways. In embodiments of the invention, the system may provide the seller with lienholder instructions, an address to mail the title and request confirmation that the title has been mailed. In other embodiments, the system may request confirmation from the buyer that the buyer has the title in hand and that the buyer will mail the title before transference of funds to the seller is executed. In other embodiments, both the buyer and seller may be invited by the system to visit a bank branch or other location with the title in hand before any transfer of funds to the seller can occur.

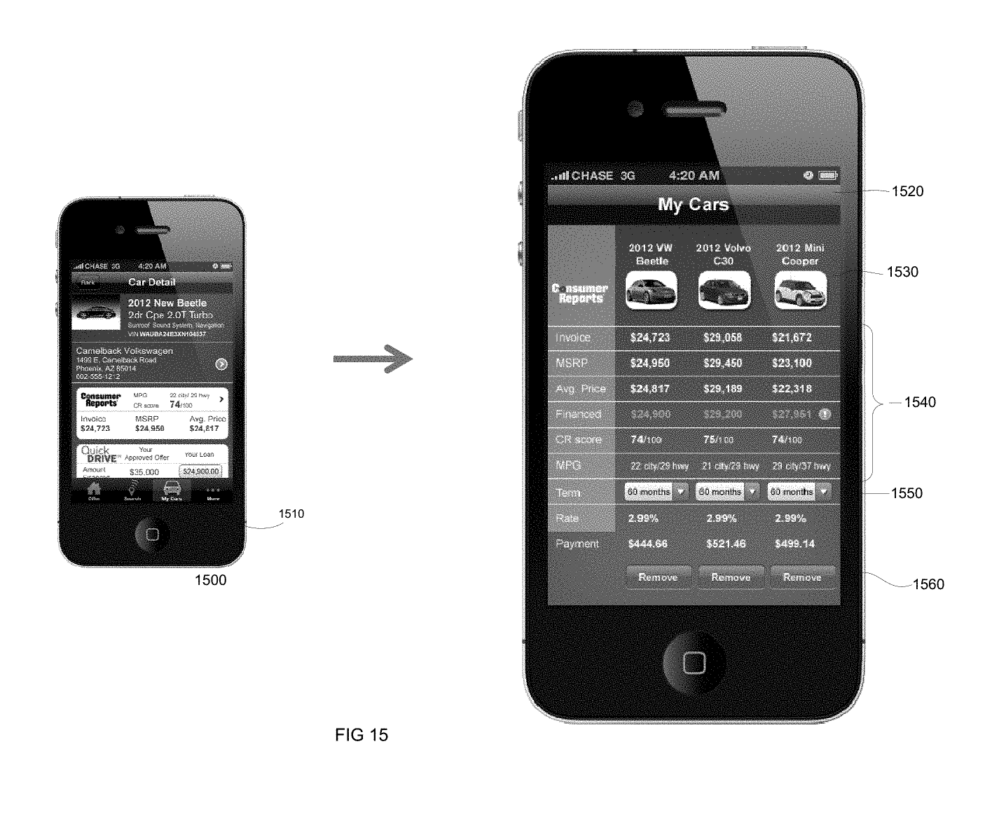

FIG. 15 is a user interface illustrating a vehicle comparison for the vehicle acquisition and management system in accordance with embodiments of the invention. From interface 1500, a user may select a “my cars” option 1510 to be directed to interface 1520. Multiple vehicles 1530 may be displayed and compared on the interface 1520 along with information 1540, loan term 1550 and the ability to add and remove vehicles 1560.

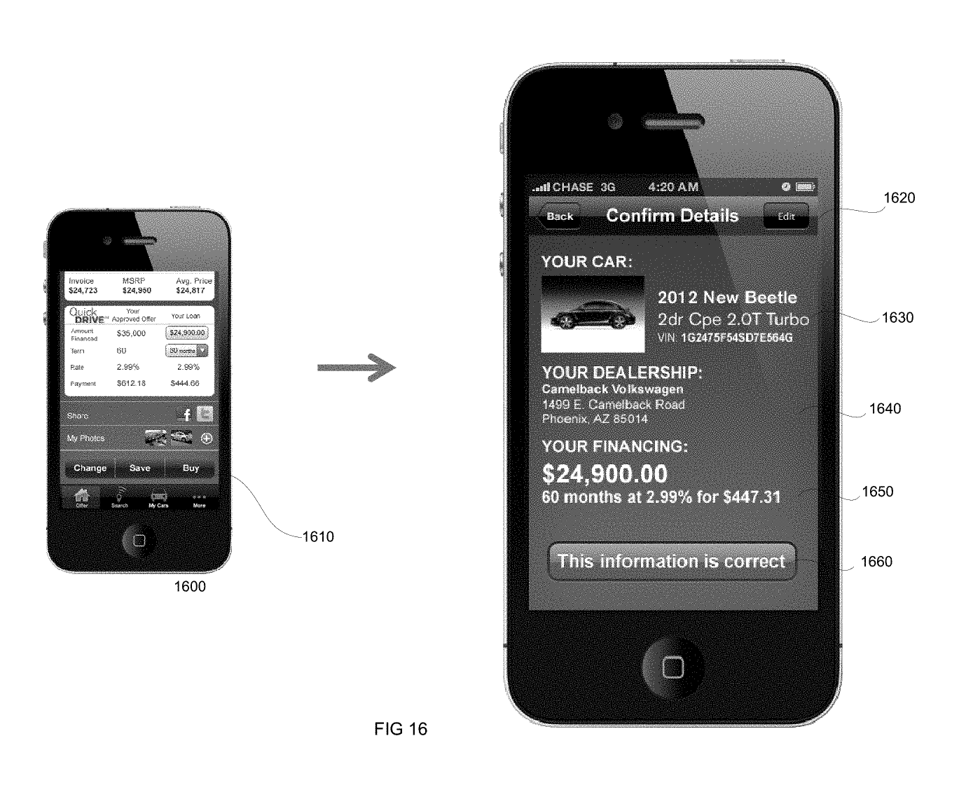

FIG. 16 is a user interface illustrating loan details for the vehicle acquisition and management system in accordance with embodiments of the invention. From a user interface 1600, a user may select a “buy” button 1610 to be directed to the interface 1620. The interface 1620 may include vehicle information 1630, dealership information 1640, financing information 1650, and a verification option 1660.

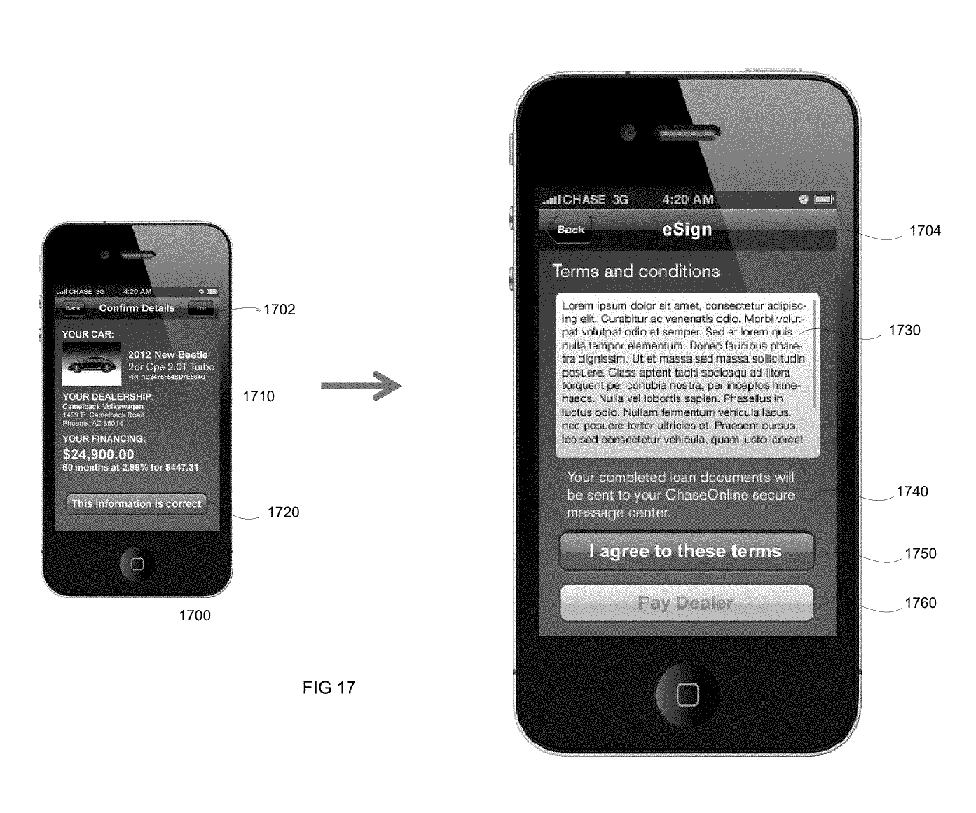

FIG. 17 is a user interface illustrating e-signing screens for the vehicle acquisition and management system in accordance with embodiments of the invention. From an interface 1700, the customer may elect to confirm details 1710 by selecting button 1720. Alternatively, the customer can edit details at 1702. If the customer chooses to confirm, the customer may be direct to e-sign interface 1704 displaying terms and conditions 1730, information 1740, an agreement button 1750, and a payment button 1760. In embodiments of the invention, the e-sign interface 1704 may include additional security features that are activated upon an attempt to complete the deal. For example, the e-sign interface may require photo-authentication through a mobile device or alternatively other biometric authentication. For photo-authentication, the mobile device may be equipped with a camera and may require a photograph of the signer to be captured, transmitted, and stored upon completion of the deal. This feature will help to verify the occurrence of transactions that may later be disputed by the customer and will protect the customer if the e-signature was falsified. Similarly, a biometric authentication, such as fingerprinting, voice authentication, iris recognition, facial recognition, or other biometric identifier may be used for authentication.

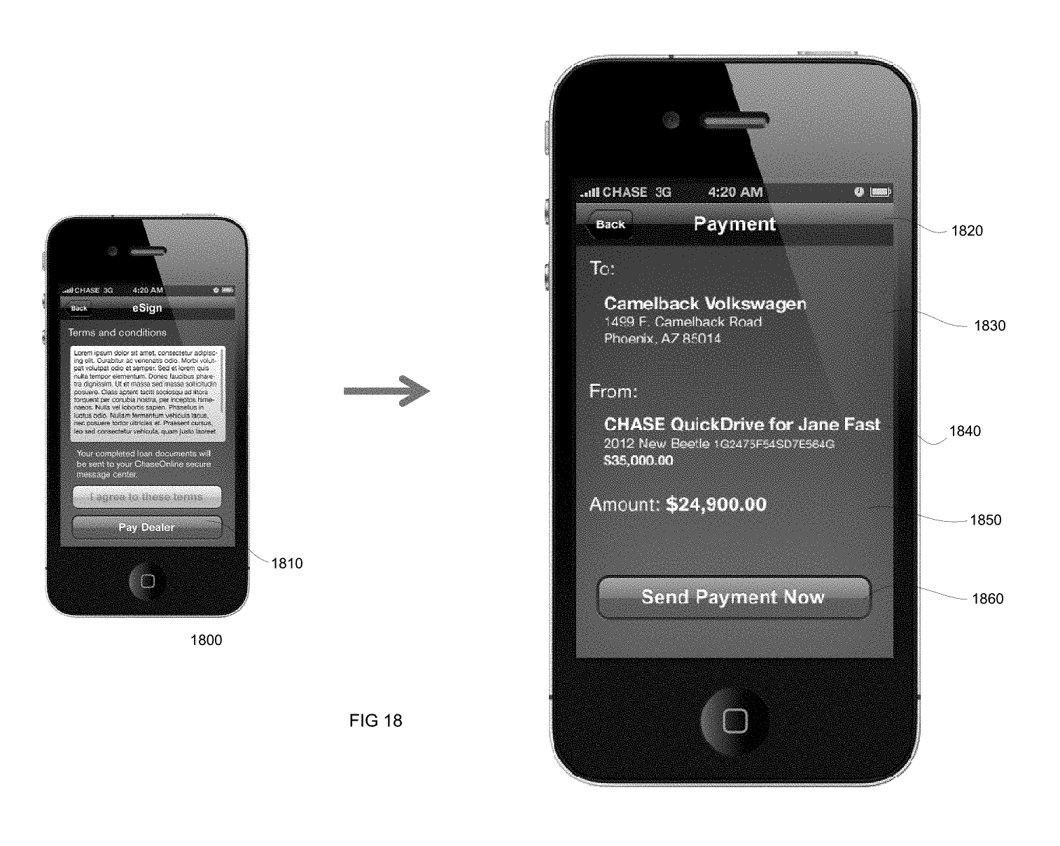

FIG. 18 is a user interface illustrating payment screens for the vehicle acquisition and management system in accordance with embodiments of the invention. From an interface 1800, a user may select to pay the dealer 1710. Potential options for paying the dealer may include devices such as “quick pay”, mobile wallet, temporary credit card, use of 3^{rd} party dealership portals, ACH, cashier's check, or other options. A payment interface 1820 may include payee information 1830, payer bank 1840, amount 1850, and a pay now option 1860.

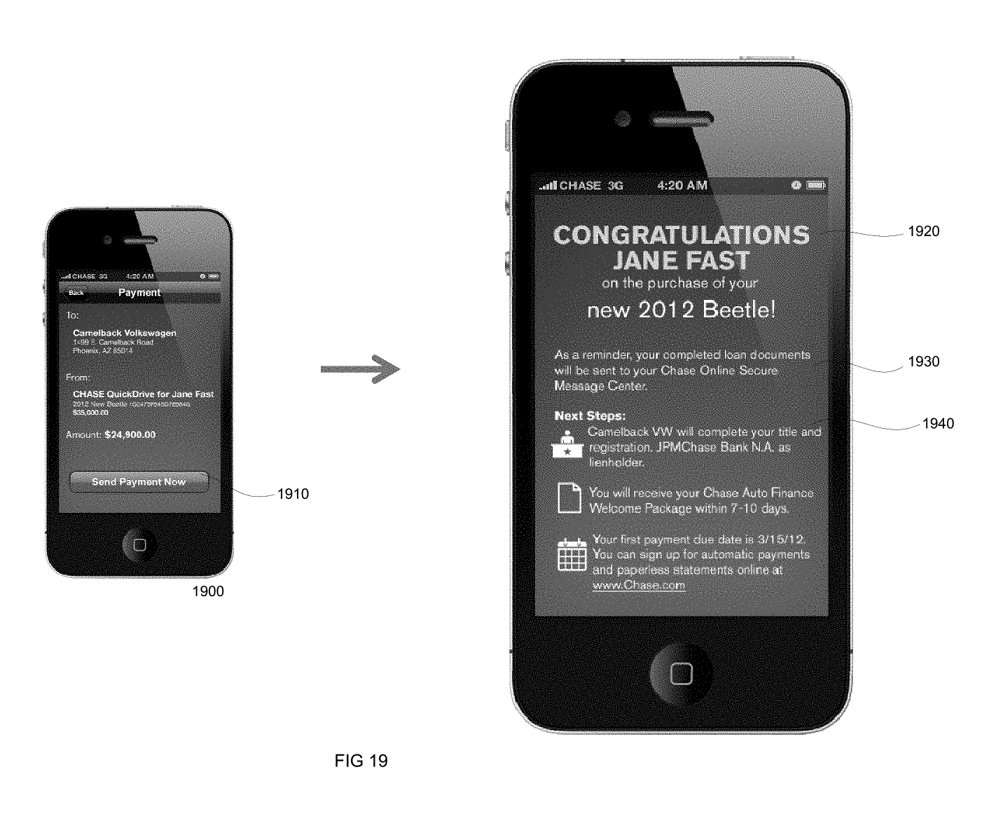

FIG. 19 is a user interface illustrating a confirmation of purchase screen for the vehicle acquisition and management system in accordance with embodiments of the invention. Upon selecting a pay now option 1910 from a user interface 1900, a congratulations screen 1920 may be provided including information 1930 and next steps 1940.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the disclosed invention.

1. A vehicle acquisition and management system for facilitating vehicle ownership for a purchasing customer, the vehicle acquisition and management system operating over at least one network and in conjunction with multiple dealership computing systems, a financial institution computing system, and a customer computing device, the system comprising:
at least one computer memory storing instructions and data received over the network from the multiple dealership computing systems;
at least one computer processor accessing the at least one computer memory, executing the stored instructions, and communicating with the financial institution computing device and the customer computing device over the network for performing steps including;
providing a mobile application displaying an interactive user interface on the customer computing device for facilitating vehicle acquisition, wherein the mobile application causes the interactive user interface to display multiple selectable vehicle identification number acquisition options, wherein the vehicle identification number acquisition options include at least a scanning option enabling the user to scan the vehicle identification number using the customer computing device and a manual entry option enabling the user to manually enter the vehicle identification number to the user interface of the customer computing device;
receiving customer input over the Internet, the customer input entered to the interactive user interface on the customer computing device for obtaining vehicle financing and providing financing information over the Internet from the financial institution computing system through the interactive user interface on the customer computing device;
receiving a vehicle identification number over the Internet input by the customer through one of the vehicle identification number acquisition options on the interactive interface provided by the mobile application on the customer computing device and processing the vehicle identification number by retrieving stored vehicle data submitted by one of the dealership computing systems and providing a display of vehicle details on the interactive user interface of customer computing device;
determining and displaying a dealer location on the interactive interface of the customer computing device and requesting and receiving a customer confirmation of the dealer location;
providing loan documents over the Internet for display on the customer computing device and requesting customer approval; and
providing a payment interface upon receiving the customer approval of the loan documents over the network through the customer computing device and transmitting funds to the dealer and providing notification over the network to the dealership computing device connected over the network upon receiving a customer command to transmit the funds.

2. The system of claim 1, wherein the processor is further programmed for obtaining the vehicle identification number through receipt of a scan of the vehicle identification number performed by the customer computing device.

3. The system of claim 1, wherein the processor is further programmed to receive one of keypad and voice entry of the vehicle identification number through the customer computing device.

4. The system of claim 1, wherein the computer processor is further programmed to access vehicle comparison data and display a vehicle comparison on the customer computing device.

5. The system of claim 1, wherein the at least one computer processor is further programmed to store vehicle data upon purchase of the vehicle and to trigger reminders and notifications through the life cycle of the vehicle.

6. The system of claim 1, wherein the at least one computer memory stores data for multiple vehicles to create a virtual garage of vehicles for the customer.

7. The system of claim 1, wherein the at least one computer processor is further programmed to obtain insurance quotes and transmit payment for insurance upon receiving a prompt from the customer computing device.

8. The system of claim 1, wherein the at least one computer processor is further programmed to obtain vehicle registration documents for the customer computing device user upon receiving a prompt.

9. The system of claim 1, wherein the at least one computer processor is further programmed to trigger a service reminder interface for the customer when stored vehicle data indicates that servicing is required.

10. The system of claim 1, wherein the at least one computer processor is further programmed to generate registration renewal reminders and inspection reminders for display by the customer computing device.

11. The system of claim 1, wherein the customer computing device is a mobile computing device.

12. The system of claim 1, wherein customer acceptance is an e-signature.

13. A method for facilitating vehicle ownership using a vehicle acquisition and management system, the method operating over at least one network and in conjunction with multiple dealership computing systems, a financial institution computing system, and a customer computing device, the method comprising:
accessing instructions and data received over the network from the multiple dealership computing systems stored in at least one computer memory; and
using a computer processor executing the stored instructions and communicating with the financial institution computing system over the network for performing steps including;
providing a mobile application displaying an interactive user interface on the customer computing device for facilitating vehicle acquisition, wherein the mobile application causes the interactive user interface to display multiple selectable vehicle identification number acquisition options, wherein the vehicle identification number acquisition options include at least a scanning option enabling the user to scan the vehicle identification number using the customer computing device and a manual entry option enabling the user to manually enter the vehicle identification number to the user interface of the customer computing device;
receiving customer input over the Internet, the customer input entered to the interactive user interface on the customer computing device for obtaining vehicle financing and providing financing information over the Internet from the financial institution computing system through a user interface on the customer computing device;
receiving a vehicle identification number over the Internet input by the customer through one of the vehicle identification number acquisition options on the interactive interface provided by the mobile application on the customer computing device and processing the vehicle identification number by retrieving stored vehicle data submitted by one of the dealership computing systems and providing a display of vehicle details on the interactive user interface of customer computing device;
determining and displaying a dealer location on the interactive interface of the customer computing device and requesting and receiving a customer confirmation of the dealer location;
providing loan documents on the customer computing device and requesting customer approval; and
providing a payment interface upon receiving a customer approval of the loan documents over the network through the user interface of the customer computing device and transmitting funds and providing a notification to the dealer over the network to the dealership computing device connected over the network upon receiving a customer command to transmit the funds.

14. The method of claim 13, further comprising obtaining the vehicle identification number upon receipt of a scan of the vehicle identification number performed by the customer computing device.

15. The method of claim 13, further comprising obtaining the vehicle identification number upon entry by the user into the customer computing device.

16. The method of claim 13, further comprising providing vehicle comparison data and displaying the vehicle comparison including market value/price on the customer computing device.

17. The method of claim 13, further comprising storing vehicle data upon purchase of the vehicle and to trigger reminders and notifications through the life cycle of the vehicle.

18. The method of claim 13, further comprising storing data for multiple vehicles to create a virtual garage of vehicles for the customer.

19. The method of claim 13, further comprising obtaining insurance quotes transmitting payment for insurance upon receiving a prompt from the customer computing device.

20. The method of claim 13, further comprising obtaining vehicle registration documents for the customer computing device user upon receiving a prompt.

21. The method of claim 13, further comprising triggering a service reminder interface for the customer when stored vehicle data indicates that servicing is required.

22. The method of claim 13, further comprising generating registration renewal reminders and inspection reminders for display by the customer computing device.

23. The method of claim 13, wherein the customer computing device is a mobile computing device.

24. The method of claim 13, wherein customer acceptance is an e-signature.

25. A vehicle acquisition and management system for facilitating vehicle ownership for a purchasing customer, the vehicle acquisition and management system operating over at least one network and in conjunction with multiple dealership computing systems, a financial institution computing system, and a customer computing device, the system comprising:
at least one computer memory storing instructions and data received over the network from the multiple dealership computing systems;
at least one computer processor accessing the at least one computer memory, executing the stored instructions, and communicating with the financial institution computing system over the network for performing steps including;
providing a mobile application displaying an interactive user interface on the customer computing device for facilitating vehicle acquisition, wherein the mobile application causes the interactive user interface to display multiple selectable vehicle identification number acquisition options, wherein the vehicle identification number acquisition options include at least a scanning option enabling the user to scan the vehicle identification number using the customer computing device and a manual entry option enabling the user to manually enter the vehicle identification number to the user interface of the customer computing device;
receiving a customer request over the network through the interactive user interface on the customer computing device to trade-in a used vehicle;
gathering data and performing a trade-in comparison for the used vehicle, the trade-in comparison including multiple entities accepting the trade-in and payment amounts for the trade-in;
performing a financial analysis by communicating with the financial institution computing system over the network based on the trade-in payment amounts and financial parameters of the customer;
providing a selection of vehicles to the customer based on the financial analysis and the data submitted by the multiple dealership computing systems;
obtaining vehicle financing through the financial institution computing system for the customer requesting the financing through the user interface of the customer computing device and providing financing information over the network through the user interface on the customer computing device;
receiving a vehicle identification number over the Internet input by the customer through one of the vehicle identification number acquisition options on the interactive interface provided by the mobile application on the customer computing device;
processing the vehicle identification number input by the customer received through communication over the network with the customer computing device and providing a display of vehicle details submitted by one of the dealership computing systems on the interactive user interface of the customer computing device;
determining and displaying a dealer location to the customer on the interactive user interface of the customer computing device and requesting and receiving customer confirmation of the dealer location from the customer utilizing the interactive user interface on the customer computing device;
providing loan documents through communication with the financial institution computing system on the interactive user interface of the customer computing device and requesting customer approval; and
providing a payment interface upon receiving the customer approval of the loan documents and transmitting funds to the dealer and notification on the dealership computing device connected over the network upon receiving a customer command to transmit the funds.
